(19) United States
(12) Patent Application Publication
(10) Pub. No.: US 2012/0170996 A1
(43) Pub. Date: Jul. 5, 2012

(54) ADHESIVE APPLICATION MODULE FOR A BATCHER UNIT IN A BOOK BLOCK FINISHING MACHINE

(76) Inventors: Michael Speller, Aurora (CA); Ross Hoge, Kirkland (CA)

(21) Appl. No.: 13/269,313

(22) Filed: Oct. 7, 2011

Related U.S. Application Data
(60) Provisional application No. 61/418,611, filed on Dec. 1, 2010.

(51) Int. Cl. B42C 9/00

(52) U.S. Cl. 412/37

(57) ABSTRACT

A batcher unit for a book block finishing machine can include a plurality of receiving members. Each receiving member can be operable to receive and stack a corresponding plurality of sheets. The batcher unit can also include a plurality of adhesive applicators. At least one adhesive applicator can be associated with each receiving member. Each adhesive applicator can be displaceable relative to its associated receiving member to apply adhesive to at least one edge of the stack of sheets in the receiving member to form a book block, and each adhesive applicator can be operable to be independently displaceable with respect to the other adhesive applicators.

### FIELD

The described embodiments relate to an adhesive application module for use in a book block finishing machine.

### INTRODUCTION

Digital printing presses are an alternative to traditional offset printing presses and can be used to create multiple copies of a printed work. In some examples of digital printing presses, the printed content is applied to a continuous length of web, and the web is then cut and sorted to form a book. One method of converting the printed continuous web into a book involves the individual pages of the printed content (i.e., the book being printed) being cut, separated and stacked into book blocks. A portion of the digital printing press known as the finishing machine or book block finishing machine can perform at least some of these operations.

Conventional finishing machines can take a considerable amount of time to allow for a format change (i.e., to accept a different book block size and shape), which may require the associated digital printing press to also stop for a period of time. This can reduce some of the “change-on-the-fly” advantage of digital printing presses.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

According to one embodiment of the invention, a batcher unit for a book block finishing machine can include a plurality of receiving members. Each receiving member can be operable to receive and stack a corresponding plurality of sheets. The batcher unit can also include a plurality of adhesive applicators. At least one adhesive applicator can be associated with each receiving member. Each adhesive applicator can be displaceable relative to its associated receiving member to apply adhesive to at least one edge of the stack of sheets in the receiving member to form a book block, and each adhesive applicator can be operable to be independently displaceable with respect to the other adhesive applicators.

Optionally, the batcher unit can also include at least one actuator connected to the plurality of adhesive applicators. The at least one actuator can be operable to displace each adhesive applicator independently with respect to the other adhesive applicators.

Optionally, the at least one actuator includes one applicator actuator associated with each adhesive applicator. Each applicator actuator can be independently operable relative to the other actuators.

Optionally, each adhesive applicator can include an adhesive applying portion movably mounted on a corresponding stationary portion. Each stationary portion can be fixed relative to its corresponding receiving member.

Optionally, each stationary portion can include a linear bearing member extending in a first direction. The corresponding adhesive applying portion can be slidably mounted on the linear rail and can be translatable in the first direction.

Optionally, each applicator actuator is disposed in one stationary portion and is drivingly connected to the corresponding adhesive applying portion to move the adhesive applying portion relative to the stationary portion in the first direction.

Optionally, the batcher unit can also include a shuttle apparatus associated with each receiving member to remove the stacks of sheets from the receiving members. The shuttle apparatus can be configured to translate the stack of sheets from the receiving member to a downstream position in a second direction while the adhesive is being applied. The second direction can be different than the first direction.

Optionally, the shuttle apparatus can include a clamp mechanism. The clamp mechanism can be operable to clamp the stacks of sheets while the adhesive is being applied. The clamp mechanism can be translatable with the shuttle in the second direction.

Optionally, each adhesive applying portion is configurable to oscillate between the first and second positions in the first direction as the clamp mechanism translates in the second direction.

Optionally, the batcher unit can also include a controller communicably linked to each adhesive applicator and the clamp mechanism. The controller can be operable to automatically control the movement of each adhesive applicator and the clamp mechanism.

Optionally, each adhesive applicator can be moveable at an adhesive applicator speed that is selectably variable.

### DRAWINGS

For a better understanding of the applicant's teachings described herein, reference will now be made, by way of example only, to the accompanying drawings which show at least one exemplary embodiment, and in which:

FIG. 1 is a perspective view of an embodiment of a batcher unit;

FIG. 2 is a perspective view of an adhesive application module that can be used with the batcher unit of FIG. 1;

FIG. 3 is a perspective view of a portion of the batcher unit of FIG. 1 identified as region 3, with a shuttle in a first position and a glue head in a lowered position;

FIG. 4 is a side elevation view of the portion of the batcher unit of FIG. 3;

FIG. 5 is a perspective view of a portion of the batcher unit of FIG. 3, with the shuttle in a second position and the glue head in a raised position;

FIG. 6 is a side elevation view of the portion of the batcher unit of FIG. 5;

FIG. 7 is a perspective view of a portion of the batcher unit of FIG. 3, with the shuttle in a third position and the glue head in the lowered position;

FIG. 8 is a side elevation view of the portion of the batcher unit of FIG. 7; and

FIG. 9 is a side elevation view of book blocks having a bead of adhesive in a stacked configuration.

For simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

Various apparatuses or processes will be described below to provide an example of an embodiment of each claimed invention. No embodiment described below limits any claimed invention and any claimed invention may cover processes or apparatuses that differ from the exemplary embodiments described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

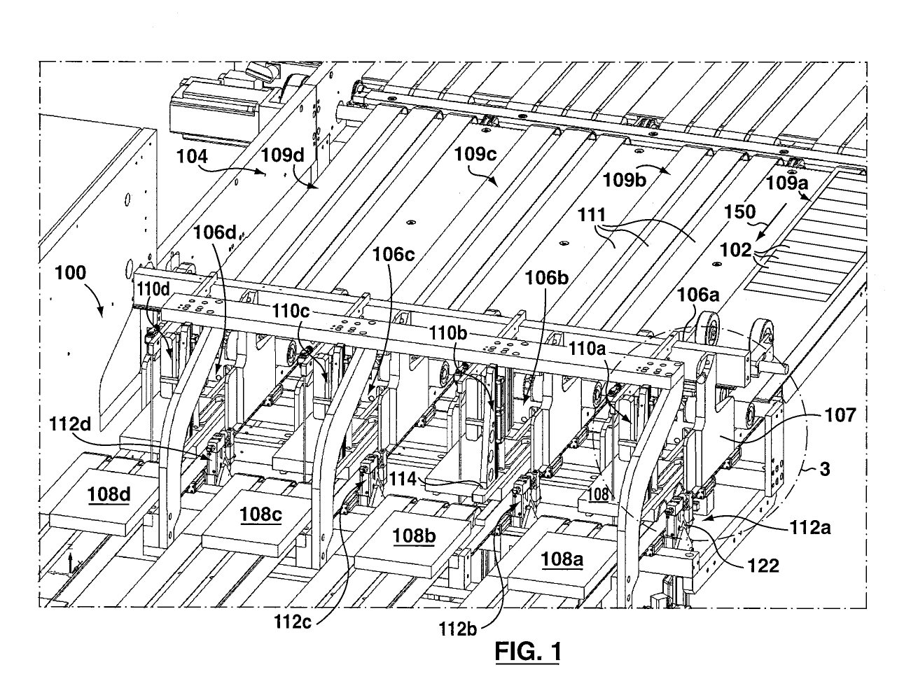

As described herein, a book block finishing machine is any machine that is operable to stack a plurality of printed sheets into one or more book blocks. Generally, the incoming printed sheets are advanced on a conveyance in a machine direction (i.e., the general direction of travel of the web and/or sheets, for example as illustrated by arrow 150 in FIG. 1) and are collected and stacked in a receiving member to form a book block. One example of a suitable receiving member is a hopper, as described below. The direction generally orthogonal to the machine direction can be referred to as the lateral or transverse direction.

For the purposes of this description, a book block comprises a plurality of sheets of paper, stacked in order, temporarily bonded together and generally taking the form of a book without a cover or other permanent binding. Book blocks may be formed having a variety of physical dimensions (length and width) based on the requirements of the finished book (i.e., paper back, hardcover, coffee table book, etc.) and may contain a variety of numbers of pages depending on the length of the book being printed. Varying the number of pages in a book block may vary the height of the book block. While the term book block is generally used in this description to describe a plurality of pages arranged in order to form the text of a book, it is understood that the term book block also refers more generally to any collection of stacked sheets or pages, the contents of which may be a book or any other type of printed media, including flyers, catalogues, directories and manuals.

The incoming sheets that will form the book block can be initially supplied to the book block finishing machine as individual sheets, or as a generally continuous, moving web of paper (or other suitable material) upon which desired text and/or graphics is printed. Such an incoming web can then be separated into a plurality of sheets, which can then be arranged into one or more steams of sheets moving through the machine. Each stream of sheets can be fed into a hopper, in which the sheets are stacked to form the book block.

Optionally, the book block finishing machine may be configured to operate in an “on-line” capacity, in which the incoming web is received from a printing engine (digital or offset) in real time (i.e. the printed web exiting the printing press is fed into the book block finishing machine). Alternatively, the book block finishing machine may be configured to operate in an “off-line” capacity in which the incoming web is unwound from a spool or roll of pre-printed material, as opposed to coming directly from the output of a printing press. In either example, the web can be supplied to the book block finishing machine at a given linear velocity or web speed that can be expressed in absolute terms, for example the web can be traveling at ten linear feet per second, or in relative terms, for example the web and/or sheets can be traveling between about 400 and 800 sheets per minute (which may represent a variety of different velocities depending on the length of each sheet), or greater than 800 sheets per minute.

An example of such a book block finishing machine is the book block finishing machine described in PCT/CA2010/000832 (Speller et al.), filed Jun. 1, 2010 and entitled “Book Block Finishing Machine,” the entirety of which is incorporated herein by reference.

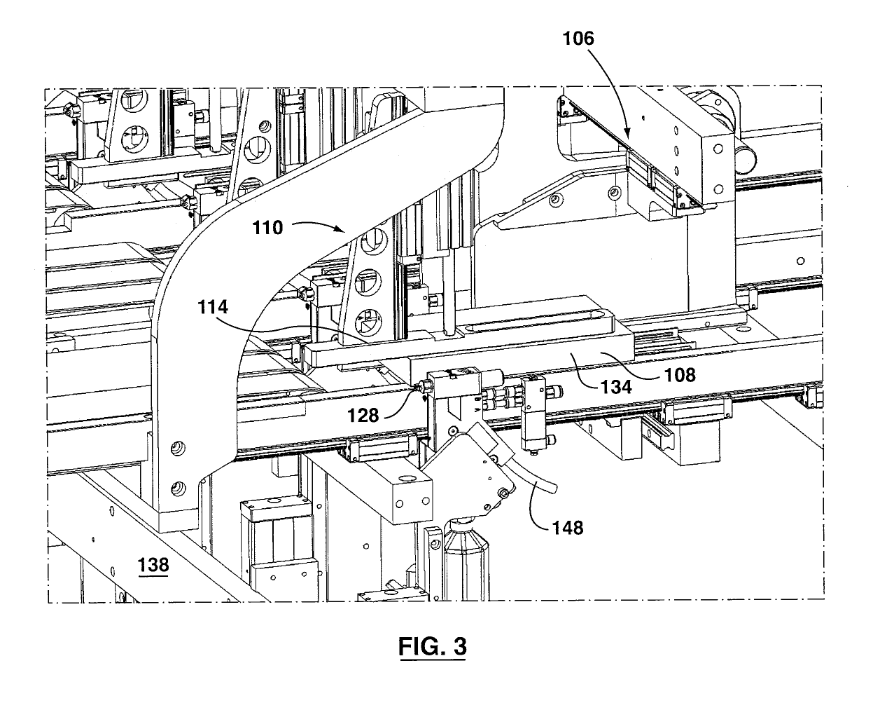

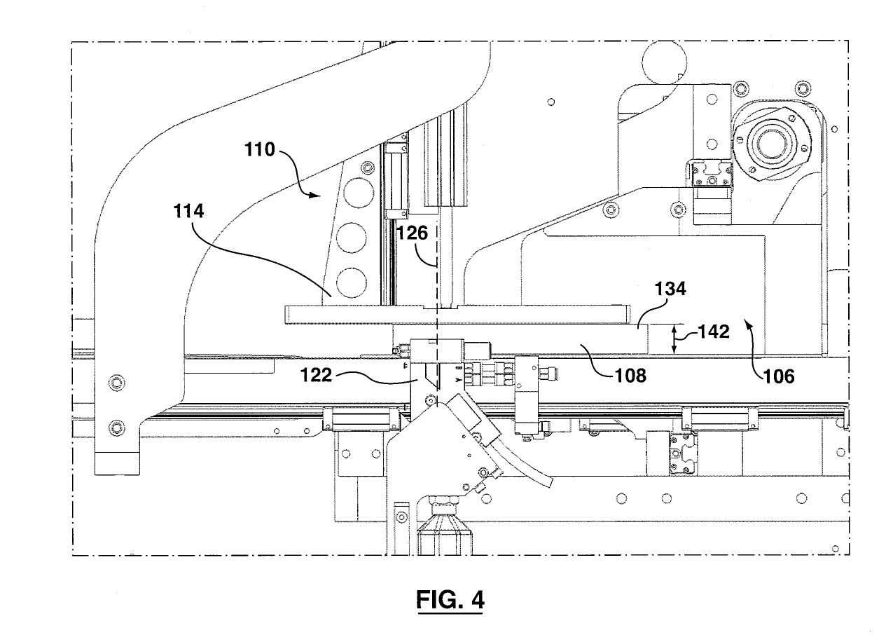

Referring to FIG. 1 an example of batcher unit 100 that is suitable for use in a book block finishing machine is illustrated. Optionally, the batcher unit 100 can be provided as a discrete, or stand-alone unit that can co-operate with, or replace, other discrete units or modules in the book block finishing machine. Alternatively, the batcher unit 100 can be incorporated as a sub-unit or sub-assembly within another unit in the book block finishing machine. In this example, the batcher unit 100 is configured to receive a plurality of sheets 102 from an upstream portion of the book block finishing machine, for example, feed conveyor 104 that may form part of a shingle and interrupt unit, to stack the sheets 102 within hoppers 106 to form book blocks 108 (FIGS. 3 and 4). Optionally, the sheets supplied to the batcher unit can be folded in the web direction. For example, incoming sheets can be folded in half, thirds or spline folded based on the nature of the printed content on the sheets.

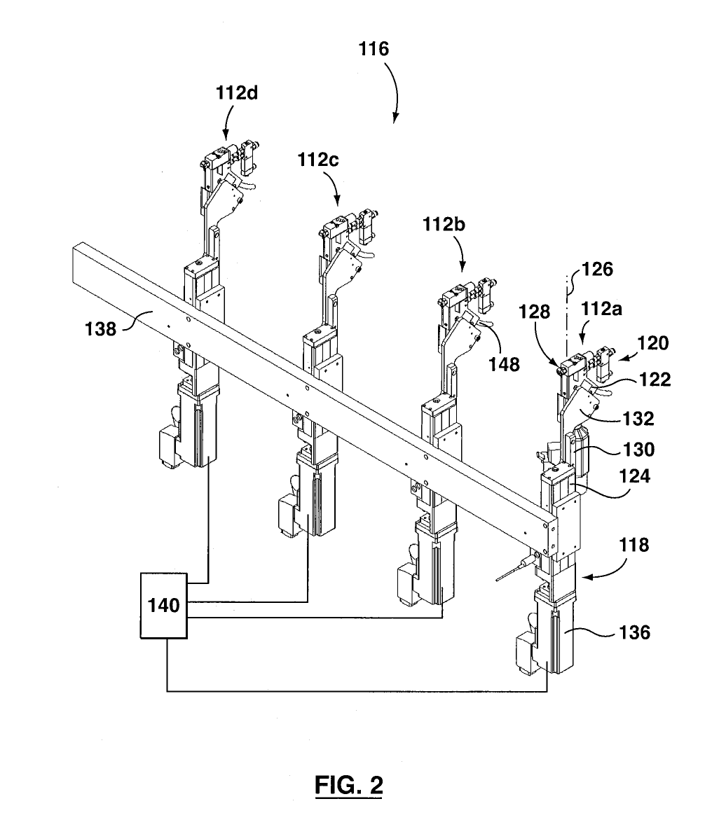

In FIGS. 2-8, portions of the book block finishing machine, including the near side wall 107 of the hopper, have been removed so that other features of the batcher unit 100 adhesive application module can be more clearly illustrated. It is understood that such removed components would be replaced when assembling and operating the batcher unit and the book block finishing machine.

Referring to FIG. 1 the batcher unit 100 is a multi-stream batch unit that includes a plurality of batch hoppers 106a-d within which a plurality of sheets 102 for a given print job (i.e., a single copy of the book being printed) are stacked to create book blocks 108a-d having the desired number of pages of the finished product (optionally ranging from a few sheets to several hundred pages).

The batcher unit 100 also includes a plurality of shuttle apparatuses 110a-d and moveable adhesive applicator mechanisms 112a-d associated with hoppers 106a-d. The shuttle apparatus 110a-d is operable to transport completed book blocks 108a-d from hoppers 106a-d for further processing. In the illustrated example, each of shuttle apparatuses 110a-d includes a clamp mechanism 114a-d that is configured to squeeze the book blocks 108a-d in a vertical direction.

The present example of the batcher unit 100 is illustrated having four hoppers 106a-d, for receiving up to four streams of sheets. The sheets 102 are provided as shingled streams (shown on the left side of FIG. 1) that are conveyed on conveyor portions 109a-d, of the feed conveyor 104. Each conveyor portion 109a-d includes three, spaced apart conveyor belts 111. Other examples of the batcher unit 100 may include a greater or fewer number of hoppers (and all related hardware). For simplicity, this description will describe the operation of the batcher unit 100 with respect to a single stream of sheets 102 entering a single hopper, hopper 106a.

Referring to FIG. 2 an embodiment of an adhesive application module 116 for use on the batcher unit 100 comprises four adhesive applicator mechanisms 112a-d. Each adhesive applicator mechanism 112 can be operable independently from the other adhesive applicator mechanisms 112.

In the illustrated example, each adhesive applicator mechanism 112 includes a stationary portion 118 and an adhesive applying portion. In the illustrated example, the adhesive applying portion comprises a moveable portion 120 that is adapted to apply adhesive to the book blocks 108. In the illustrated example, the moveable portion 120 includes a glue head module 122 that is slidably mounted on a vertically oriented linear bearing 124, so that the glue head module 122 can translate in the vertical direction, along a translation axis 126. The glue head module 122 includes a glue nozzle 128 that is coupled to a support member 130 using a bracket 132. The size and shape of the support member 130 and the bracket 132 can be selected based on the configuration of the hoppers 106, so that the glue nozzle 128 can be positioned adjacent the side edge 134 (FIGS. 3-8) of a book block 108 being removed from the hoppers 106.

The glue nozzle 128 can be any suitable glue nozzle, including a slot-type glue nozzle.

The stationary portion 118 of the adhesive applicator mechanism 112 includes the linear bearing 124 and an actuator 136 for moving the moveable portion 120 in the vertical direction. The actuator 136 can be any suitable type of linear actuator that can drive the moveable portion 120, including a servo motor driving a ball screw, and a pneumatic cylinder.

The stationary portions 118 of the adhesive applicator mechanisms 112 are mounted on a lateral beam 138, that is connected to the frame of the batcher unit 100. The lateral beam 138 can be sized to provide a desired degree of stiffness, which may help inhibit vibrations and may improve the accuracy of the gluing process. Optionally, the clamping mechanism, such as clamp 114, can be also constructed to have a high degree of stiffness.

Each actuator 136 can be connected to a batcher unit controller 140, and/or a central machine controller (not shown), which can be configured to control the range of motion, and speed (or rate of travel) of each actuator 136 separately. The actuators 136 and controller 140 can also be used to make slight variations in the range of motion between adhesive applicator mechanisms 112 even when all of the hoppers 106 are being used to stack the same book (i.e., a block containing the same number of sheets 102).

For example, the continuous web of paper that is used to form the sheets 102 can have minor variations in thickness across its width, which may cause slight variations in the height 142 (FIG. 4) of the stacked book blocks 108. Also, the edge portions of the web may be slightly more susceptible to curving or developing a wavy profile during the printing process than the central portions of the web. In this instance, a stack of sheets cut from the edge portions of the web may have a slightly greater thickness than a stack of sheets cut from the central portion of the web.

In such circumstances, it may be desirable to increase the range of motion of the outer adhesive applicator mechanisms 112a,d (located at the left and right when viewed in FIG. 2), relative to range of motion of the inner adhesive applicator mechanisms 112b,c (the middle two applicators 112 as illustrated in FIG. 2), even if the stacks contain the same number of sheets. In some examples, such minor variations in range of motion may be the difference between properly gluing all of the sheets in the book block, and failing to properly bond the one or more sheets on the bottom or top of the book block 108. Even a single missing or misaligned sheet that is not bonded with the adhesive may be undesirable and may interfere with subsequent processing of the book block (for example binding, etc.).

Referring to FIGS. 4-8, during a batching sequence or batching cycle (i.e., the cycle of making one completed book block) the desired number of sheets 102 are fed from the feed conveyor into a corresponding one of the hoppers 106 of the batcher unit 100. When the book block is completed it can be clamped the clamping mechanism 114 of the movable shuttle 110.

Optionally, the clamp grips the book block 108 slightly inward from the clamped edge 134, which may help to reduce the chances of adhesive contacting the clamp 114.

Once the clamp 114 has engaged the book block 108, the shuttles 110 can be moved in the downstream direction, carrying the book blocks out of the hoppers 106. The shuttles may be moved using any suitable actuator including hydraulic and pneumatic cylinders, ball screws, gears, chain drives and belt drives (not shown).

Upon leaving its hopper 106, each book block 108 is translated past the adhesive applicator mechanisms 112, where glue is applied to the binding edge 134 of the book block 108 (for example on the book spine) using the glue head module 122 of adhesive applicator mechanisms 112. FIGS. 3 and 4, 5 and 6 and 7 and 8 illustrate a sequential progression of a book block 108 being translated past a glue head module 122.

When applying the glue, the batcher unit is configured to impart relative movement between the book block and the adhesive applicator mechanisms in two different directions. In the described examples the clamped book blocks 108 are horizontally translated past the adhesive applicator mechanisms 112 while the glue head modules 122 are translated in a direction orthogonal to the book block movement (e.g. vertically). The range of motion of the glue head module 122 can correspond to the thickness of the book block 108. In FIGS. 3 and 4, the book block is in a first position and the glue head module 122 is in a lowered position, so that the glue nozzle 128 is generally aligned with the bottom sheet, or sheets, in the book block 108.

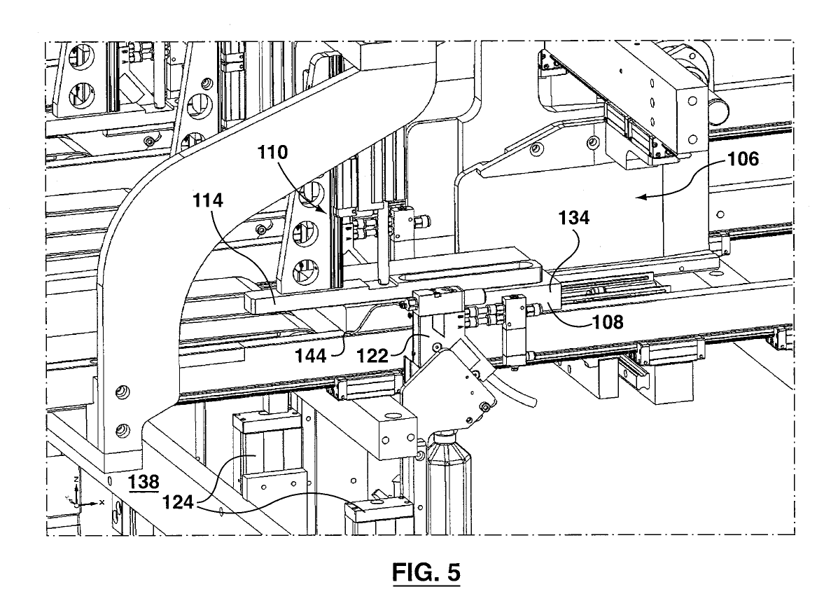

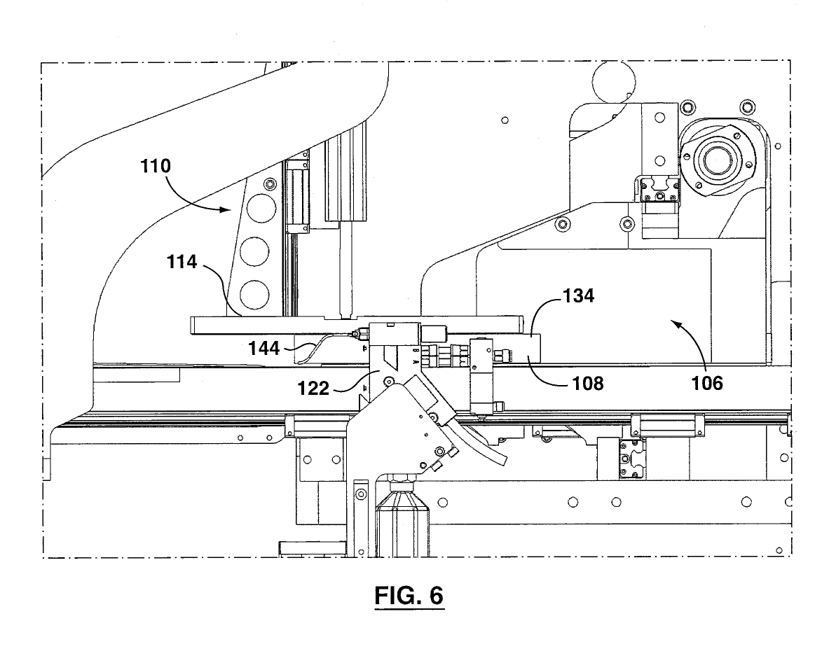

FIGS. 5 and 6 illustrate the book block 108 moved to a second position, downstream from the first position and the glue head module 122 is moved to a raised position, in which the glue nozzle 128 is positioned to apply adhesive to the top sheet, or sheets, in the book block 108.

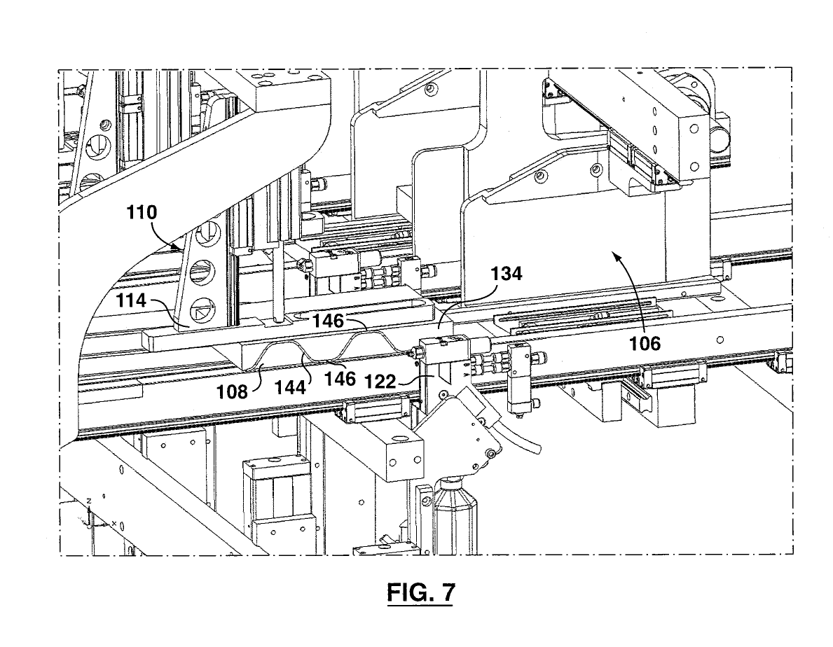

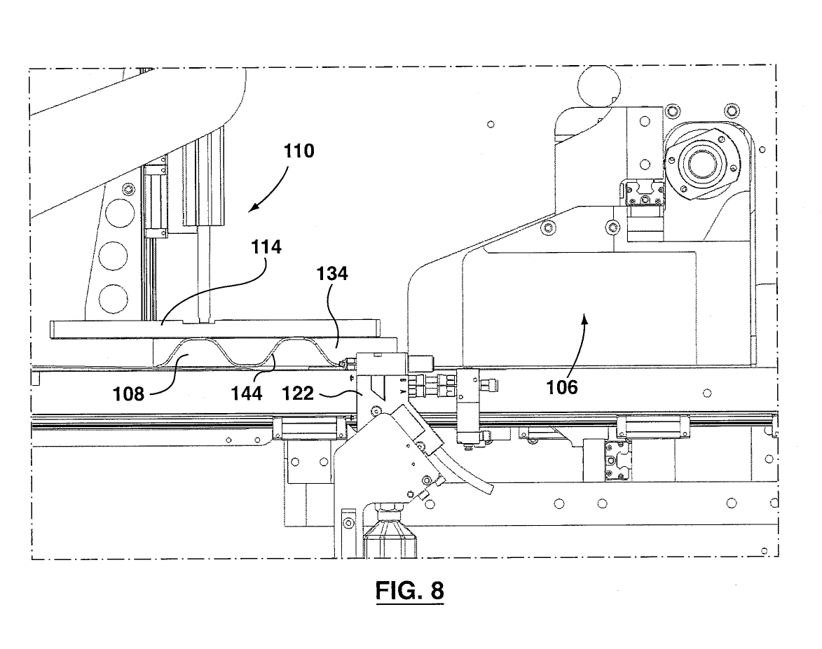

In FIGS. 7 and 8, the book block 108 is moved to a third downstream position and the glue head module 122 has returned to its lowered position.

The resulting combination of horizontal and vertical movement, of the book block 108 and the glue head module 122 respectively, can produce a bead of adhesive 144 that traces a path across the edge 134 of the book block 108. In some examples the path may resemble a sine curve, and in other examples, as illustrated, the relative speeds of the book block 108 and the glue head module 122 can be adjusted so that the adhesive bead 144 traces a modified sine curve pattern having extended pauses at the peaks 146 to apply extra adhesive to the top and bottom pages in the book block, as shown in FIG. 7.

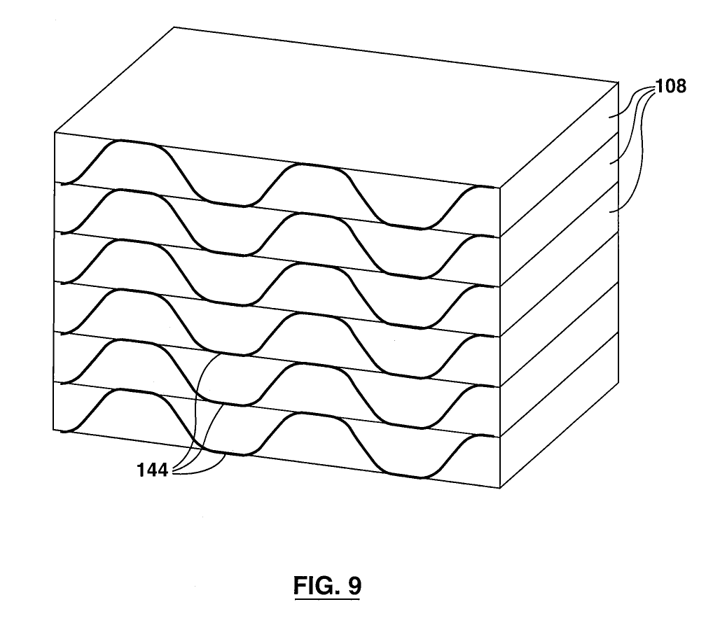

Optionally, the bead of adhesive 144 can be applied in generally the same pattern, or path, on each book block 108. If the bead of adhesive 144 is applied in generally the same pattern on multiple book blocks, when/if completed book blocks 108 are stacked on top of each other for temporary storage or handling, as shown in FIG. 9, it may be less likely that the bead of adhesive 144 on one book block 108 will come into contact with the bead of adhesive 144 on another book block 108. This arrangement may be desirable if the book blocks 108 are stacked while the adhesive is still sticky (for example if the book blocks are stacked before the adhesive has adequately cured/dried), because it may reduce the likelihood of the adjacent adhesive beads 144 becoming stuck to each other.

Optionally, the shuttle 110, clamp 114 and adhesive applicator actuator 136 can all be communicably connected to the batcher unit controller 140, which can be configured automatically control the operation of these elements in the manner described above. The batcher unit controller 140 can be a combination of both hardware and software and can be configured as a stand-alone controller or integrated as a module in another controller.

The range of motion of the each glue head module 122 (for example between its raised and lowered positions) is independently adjustable and can be set based on the dimensions of the book being printed, a sensed height of the book block in the hopper, or any other suitable inputs, including, for example, operator input corrections.

Glue/adhesive can be stored within the glue head module 122 or supplied from an external source (not shown) by a glue supply line 148.

Once the glue 144 is applied, the clamp 114 can release the book block onto a book block conveyor downstream from the adhesive applicator mechanisms 112.

Optionally, the adhesive 144 used may be selected to have desirable resilient properties to keep the book block 108 intact during transport while still allowing flexibility for subsequent handling and processing. The glued book block 108 is then moved down a conveyor belt for further processing. In the present example, the adhesive 144 applied to the book block in the batcher unit 100 is a temporary adhesive that is not intended to remain on the final product.

What has been described above has been intended to be illustrative of the invention and non-limiting and it will be understood by persons skilled in the art that other variants and modifications may be made without departing from the scope of the invention as defined in the claims appended hereto.

1. A batcher unit for a book block finishing machine, the batcher unit comprising:
a plurality of receiving members, each receiving member operable to receive and stack a corresponding plurality of sheets; and
a plurality of adhesive applicators, at least one adhesive applicator associated with each receiving member, each adhesive applicator displaceable relative to its associated receiving member to apply adhesive to at least one edge of the stack of sheets in the receiving member to form a book block, and each adhesive applicator operable to be independently displaceable with respect to the other adhesive applicators.

2. The batcher unit of claim 1, further comprising at least one actuator connected to the plurality of adhesive applicators, the at least one actuator operable to displace each adhesive applicator independently with respect to the other adhesive applicators.

3. The batcher unit of claim 2, wherein the at least one actuator comprises one applicator actuator associated with each adhesive applicator, each applicator actuator being independently operable relative to the other actuators.

4. The batcher unit of claim 3, wherein each adhesive applicator comprises an adhesive applying portion movably mounted on a corresponding stationary portion, each stationary portion being fixed relative to its corresponding receiving member.

5. The batcher unit of claim 4, wherein each stationary portion comprises a linear bearing member extending in a first direction and the corresponding adhesive applying portion is slidably mounted on the linear rail and is translatable in the first direction.

6. The batcher unit of claim 5, wherein each applicator actuator is disposed in one stationary portion and is drivingly connected to the corresponding adhesive applying portion to move the adhesive applying portion relative to the stationary portion in the first direction.

7. The batcher unit of claim 6, further comprising a shuttle apparatus associated with each receiving member to remove the stacks of sheets from the receiving members, the shuttle apparatus being configured to translate the stack of sheets from the receiving member to a downstream position in a second direction while the adhesive is being applied, the second direction being different than the first direction.

8. The batcher unit of claim 7, wherein the shuttle apparatus comprises a clamp mechanism, the clamp mechanism operable to clamp the stacks of sheets while the adhesive is being applied, the clamp mechanism being translatable with the shuttle in the second direction.

9. The batcher unit of claim 8, wherein each adhesive applying portion is configurable to oscillate between the first and second positions in the first direction as the clamp mechanism translates in the second direction.

10. The batcher unit of claim 9, further comprising a controller communicably linked to each adhesive applicator and the clamp mechanism, the controller operable to automatically control the movement of each adhesive applicator and the clamp mechanism.

11. The batcher unit of any one of claims 1, wherein each adhesive applicator is moveable at an adhesive applicator speed, the adhesive applicator speed being selectably variable.
